(19) United States
(12) Patent Application Publication
(10) Pub. No.: US 2006/0292472 A1
(43) Pub. Date: Dec. 28, 2006

(54) Electrophotographic toner using metal containing compound

(76) Inventors: Kaori Ono, Tokyo (JP); Koji Daifuku, Tokyo (JP)

Correspondence Address: CANTOR COLBURN, LLP, 55 GRIFFIN ROAD SOUTH, BLOOMFIELD, CT, 06002, US

(21) Appl. No.: 11/454,211

(22) Filed: Jun. 15, 2006

(30) Foreign Application Priority Data
Jun. 23, 2005 (JP) JP2005-183066
Mar. 17, 2006 (JP) JP2006-074180

(51) Int. Cl. G03G 9/08

(52) U.S. Cl. 430/108.3; 430/108.2; 430/137.14

(57) ABSTRACT

An electrophotographic toner is disclosed, comprising at least a metal containing compound represented by the following formula: 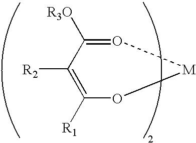
wherein M is a divalent metal ion, and R₁, R₂ and R₃ are each a hydrogen atom or a substituent. A preparation method of the toner is also disclosed.

This application claims priority from Japanese Patent Application No. JP2005-183066 filed on Jun. 23, 2005, and JP2006-074180 filed on Mar. 17, 2006, which are incorporated hereinto by reference.

### FIELD OF THE INVENTION

The present invention relates to electrophotographic toners by use of compounds capable of supplying metal ions.

### BACKGROUND OF THE INVENTION

Performances required of electrophotographic toners used in color copier (registered trade name) and color printers employing electrophotography include, for example, color reproduction, and transparency and lightfastness of images. Commonly used electrophotographic toners in which pigments as colorants are dispersed in the interior of colored particles, exhibit superior lightfastness, while such colorants are insoluble and aggregate easily, leading to reduced transparency and hue shift of transmitted color.

Accordingly, there were disclosed toners in which a colorant was changed from a pigment to a dye, as described, for example, in JP-A No. 3-276161 (hereinafter, the term, JP-A refers to Japanese Patent Application Publication). While such toners exhibit superior transparency and improved hue shift, problems arose in lightfastness. Further, conventionally used dyes have a relatively low molecular weight and easily sublime at the stage of thermal-fixing, resulting in defects such as staining on the roller surfaces or in the interior of printers, reduced image density and bleeding-out.

Recently, to overcome such defects, there was disclosed a toner using a metal complex dye as a colorant, as described in JP-A No. 10-20559. Whereas a toner containing the foregoing metal complex dye exhibits superior lightfastness, such a toner exhibits low solubility, resulting in different reflection spectra after printing, caused by aggregation or the like.

### SUMMARY OF THE INVENTION

In light of the foregoing, the present invention has come into being.

It is an object of the invention to provide an electrophotographic toner exhibiting reduction of problems such as re-diffusion, bleeding and sublimation and enhanced dye durability (such as lightfastness).

As a result of extensive study by the inventors of this application, it was proved that allowing a metal-containing compound to be stably dispersed in an electrophotographic toner promptly promotes proceeding of chelating reaction between the metal-containing compound and a dye, leading to the present invention. The above-mentioned object of the invention can be realized by the following constitution.

Thus, one aspect of the invention is directed to an electrophotographic toner comprising at least a metal containing compound represented by the following formula (1): 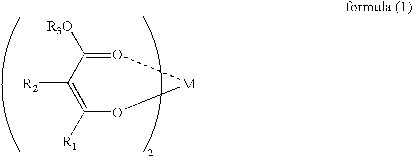
wherein M represents a divalent metal ion; R₁ represents a hydrogen atom or a substituent; R₂ represents a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group; and R₃ represents a hydrogen atom, an alkyl group, an alkenyl group, alkynyl group, an aryl group or a heterocyclic group.

Another aspect of the invention is directed to an electrophotographic toner obtained by a process of dissolving the foregoing metal containing compound of formula (1), together with a dye in a solution, depositing them as solids through a submerged desiccation method, dispersing the solids in liquid and allowing the solids to coalesce with a latex resin.

Preferred embodiments of the invention are disclosed in the dependent claims.

According to the invention, OHP (overhead projection) quality exhibiting high transparency can be achieved and there can also be provided images exhibiting superior storage stability as well as improved lightfastness over a long duration. Further, there has been achieved improvement in heat resistance (sublimation property) which has been a problem in toners using dyes.

### DETAILED DESCRIPTION OF THE INVENTION

While the present invention will hereinafter be described in connection with preferred embodiments thereof, it will be understood that it is not intended to limit the invention to those embodiments. On the contrary, it is intended to cover all alternatives, modifications, and equivalents as may be included within the spirit and scope of the invention as defined by the appending claims.

In the foregoing formula (2), M represents a divalent metal ion and preferably a divalent transition metal ion. Of divalent transition metal ions, nickel (Ni²⁺), copper (Cu²⁺) and zinc (Zn²⁺) ions are more preferred in terms of color of a metal containing compound and color of a chelated dye, and divalent copper ion is still more preferred. The metal containing compound may contains neutral ligand(s), depending on a central metal. Typical examples of such a ligand include H₂O and NH₃.

In one preferred embodiment of the invention, the metal containing compound of the invention can be obtained by synthesis of a compound represented by the following formula (2), which is further reacted with a divalent metal compound. These metal containing compounds can be synthesized in accordance with methods described in “Chelate Kagaku (5) Sakutaikagaku Jikkenho I (Chelate Chemistry 5, Experiment of Chelate Chemistry I), published by Nanko-do. Examples of a divalent metal compound usable in the invention include nickel chloride, nickel acetate, magnesium chloride, calcium chloride, barium chloride, zinc chloride, zinc acetate, titanium (II) chloride, iron (II) chloride, copper (II) chloride, cobalt chloride, manganese chloride, lead chloride, lead acetate, mercury chloride, and mercury acetate. Of those metal compounds, zinc chloride, zinc acetate, nickel chloride, nickel acetate, copper chloride and copper acetate are preferred in terms of color of a metal containing compound and color of a chelated dye, and copper acetate is more preferred.

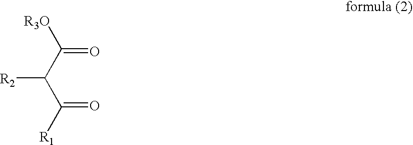

In the foregoing formula, R₁ represents a hydrogen atom or a substituent. Examples of the substituent of R₁ include an alkyl group (e.g., methyl, ethyl, propyl, isopropyl, tert-butyl, pentyl, hexyl, octyl, dodecyl, tridecyl, tetradecyl, pentadecyl, chloromethyl, trifluoromethyl, trichloromethyl, tribromomethyl, pentafluoroethyl, methoxyethyl), a cycloalkyl group (e.g., cyclopentyl, cyclohexyl), an alkenyl group (e.g., vinyl, allyl), an alkynyl group (e.g., ethynyl, propargyl), an aryl group (e.g., phenyl, naphthyl, p-nitrophenyl, p-fluorophenyl, p-methoxyphenyl), a heterocyclic group (e.g., furyl, thienyl, pyridyl, pyridazyl, pyrimidyl, pyrazyl, triazyl, imidazolyl, pyrazolyl, thiazolyl, benzoimidazolyl, benzooxazolyl, quinazolyl, phthalazyl, pyrrolidyl, imidazolidyl, morpholyl, oxazolidyl), an alkoxycarbonyl group (e.g., methoxycarbonyl, ethoxycarbonyl, butoxycarbonyl, octyloxycarbonyl, dodecyloxycarbonyl), a cycloalkoxy group (e.g., cyclopentyloxy, cyclohexyloxy), an aryloxycarbonyl group (e.g., phenoxycarbonyl, naphthyloxycarbonyl), a sulfamoyl group (e.g., aminosulfonyl, methylaminosulfonyl, dimethylaminosulfonyl, butylaminosulfonyl, hexylaminosufonyl, cyclohexylaminosulfonyl, octylaminosulfonyl, dodecylaminosulfonyl, phenylaminosulfonyl, naphthylaminosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), a carbamoyl group (e.g., aminocarbony, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), a sufinyl group (e.g., methylsulfinyl, ethylsulfinyl, butylsulfinyl, cyclohexylsulfinyl, 2-ethylhexylsulfinyl, dodecysulfinyl, phenylsufinyl, naphthylsulfinyl, 2-pyridylsulfiny), an alkylsulfonyl group (e.g., methylsulfinyl, ethylsulfinyl, butylsulfinyl, cyclohexylsulfinyl, 2-ethylhexylsulfinyl, dodecylsufinyl), an arylsulfonyl group (e.g., phenylsulfonyl, naphthylsulfonyl, 2-pyridylsulfonyl), and cyano group.

R₁ is preferably a hydrogen atom, an alkyl group, an alkenyl group, an aryl group, a heterocyclic group, an alkoxycarbonyl group, an acyl group, a carbamoyl group or cyano group, and more preferably a hydrogen atom, an alkyl group, an aryl group, a heterocyclic group or cyano group. These groups may be substituted by other substituent groups.

In the foregoing formula, R₂ represents a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group.

Specifically, an alkyl group includes, for example, methyl, ethyl, propyl, isopropyl, tert-butyl, pentyl, hexyl, octyl, dodecyl, tridecyl, tetradecyl, pentadecyl, chloromethyl, trifluoromethyl, trichloromethyl, tribromomethyl, pentafluoroethyl and methoxyethyl; an alkenyl group includes, for example, vinyl and allyl; an alkynyl group includes, for example, ethynyl and propargyl; an aryl group includes, for example, phenyl, naphthyl, p-nitrophenyl, p-fluorophenyl and p-methoxyphenyl; a heterocyclic group includes, for example, furyl, thienyl, pyridyl, pyridazyl, pyrimidyl, pyrazyl, triazyl, imidazolyl, pyrazolyl, thiazolyl, benzoimidazolyl, benzooxazolyl, quinazolyl, phthalazyl, pyrrolidyl, imidazolidyl, morpholyl and oxazolidyl; an alkoxycarbonyl group includes, for example, methoxycarbonyl, ethoxycarbonyl, butoxycarbonyl, octyloxycarbonyl and dodecyloxycarbonyl; an aryloxycarbonyl group includes, for example, phenoxycarbonyl and naphthyloxycarbonyl; a carbamoyl group include, for example, aminocarbony, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl and 2-pyridylaminocarbonyl; a sulfamoyl group includes, for example, aminosulfonyl, methylaminosulfonyl, dimethylaminosulfonyl, butylaminosulfonyl, hexylaminosufonyl, cyclohexylaminosulfonyl, octylaminosulfonyl, dodecylaminosulfonyl, phenylaminosulfonyl, naphthylaminosulfonyl and 2-pyridylaminosulfonyl; a sufinyl group includes, for example, methylsulfinyl, ethylsulfinyl, butylsulfinyl, cyclohexylsulfinyl, 2-ethylhexylsulfinyl, dodecysulfinyl, phenylsufinyl, naphthylsulfinyl and 2-pyridylsulfiny; an alkylsulfonyl group includes, for example, methylsulfinyl, ethylsulfinyl, butylsulfinyl, cyclohexylsulfinyl, 2-ethylhexylsulfinyl and dodecylsufinyl; an alkylsulfonyl group includes, for example, methylsulfinyl, ethylsulfinyl, butylsulfonyl, cyclohexylsulfonyl, 2-ethylhexylsulfonyl and dodecylsulfonyl; an arylsulfonyl group include, for example, phenylsulfonyl, naphthylsulfonyl and 2-pyridylsulfonyl. R₂ is preferably a hydrogen atom, an alkyl group, an aryl group, a heterocyclic group, an alkoxycarbonyl group or cyano group; and more preferably a hydrogen atom, an alkyl group, an aryl group, a heterocyclic group or cyano group. Those groups may be substituted by substituents.

In the foregoing formula, R₃ represents a hydrogen atom, an alkyl group, an alkenyl group, an alkynyl group, an aryl group or a heterocyclic group. An alkyl group includes, for example, methyl, ethyl, propyl, isopropyl, tert-butyl, pentyl, hexyl, octyl, dodecyl, tridecyl, tetradecyl, pentadecyl; an alkenyl group includes, for example, vinyl and allyl; an alkynyl group includes, for example, ethynyl and propargyl; an aryl group includes, for example, phenyl, naphthyl, p-nitrophenyl, p-fluorophenyl and p-methoxyphenyl; a heterocyclic group includes, for example, furyl, thienyl, pyridyl, pyridazyl, pyrimidyl, pyrazyl, triazyl, imidazolyl, pyrazolyl, thiazolyl, benzoimidazolyl, benzooxazolyl, quinazolyl, phthalazyl, pyrrolidyl, imidazolidyl, morpholyl and oxazolidyl. R₃ is preferably an alkyl group or an aryl group. Those alkyl group, alkenyl group, alkynyl group and aryl group may be substituted by a substituent.

R₁ and R₂ or R₂ and R₃ may combine with each other to form a 5- or 6-membered ring.

R₁ or R₂ is preferably an electron-withdrawing group. The electron-withdrawing group refers to a group exhibiting a positive value of Hammett substituent constant (σp). More preferably, the total of σp values of R₁ and R₂ is 0.2 to 2.0. When, in m- or p-substituted aromatic compounds, k₀ and k are respectively defined as reaction rate constants of an unsubstituted compound and a substituted one, the Hammett substituent constant is defined by the following Hammett equation:
log(k/k₀)=ρσ
where σ is a substituent constant (or also called σ value); and ρ is a reaction constant (or also called ρ value). In the foregoing Hammett equation, the dissociation reaction of benzoic acid and its derivatives in an aqueous solution at 25° C. is defined as ρ=1. Hammett substituent constants are referred to Journal of medicinal Chemistry, 1973, Vol. 16, No. 11, 1207-1216.

Specific examples of an electron-withdrawing group include a substituted alkyl group (e.g., halogen-substituted alkyl), a substituted alkenyl group (e.g., cyanovinyl), a substituted or unsubstituted alkynyl group (e.g., trifluoromethylacetylenyl, cyanoacetylenyl), a substituted aryl group (e.g., cyanophenyl), a substituted or unsubstituted heterocyclic group (e.g., pyridyl, triazinyl, benzoxazolyl), a halogen atom, cyano group, an acyl group (e.g., acetyl, trifluoroacetyl, formyl), a thioacetyl group (e.g., thioacetyl, thioformyl), a thiooxalyl (e.g., ethylthioxalyl), an oxamoyl group (e.g., methyloxamoyl), an oxycarbonyl group (e.g., ethoxycarbonyl), a carboxyl group, a thiocarbonyl group (e.g., ethylcarbonyl), a carbamoyl group, a thicarbamoyl group, a sulfonyl group, a sulfinyl group, an oxysulfonyl group (e.g., ethoxysulfonyl), a thiosulfonyl group (e.g., ethylthiosulfonyl), a sulfamoyl group, an oxysulfinyl group (e.g., methoxysulfinyl), a thiosufinyl group (e.g., methylthiosulfinyl), a sulfamoyl group, a phospholyl group, nitro group, imino group, a N-carbonylimino group (e.g., N-acetylimino), a N-sulfonylimino group (N-methanesulfonylimino), a dicyanoethylene group, ammonium group, sulfonium group, phosphonium group, a pyrrilium group and immonium group. Of the foregoing groups, a substituted alkyl group, a substituted aryl group, cyano group, an acyl group, oxycarbonyl group, nitro group and cyano group are preferred. Preferred examples thereof include a cyano group, a trifluoromethyl group, a trichloromethyl group, a nitro group, a sulfinyl group or a sulfonyl group, an aryl group substituted by a cyano group, a trifluoromethyl group, a trichloromethyl group, a nitro group, a sulfinyl group or a sulfonyl group, or an alkenyl group substituted by a cyano group, a trifluoromethyl group, a trichloromethyl group, a nitro group, a sulfinyl group or a sulfonyl group.

In electrophotographic toners relating to the invention, a total σp value of R₁ and R₂ of 0.2 to 2.0 enhances reactivity between the afore-mentioned metal containing compound and a dye chelatable with the metal containing compound, enabling to reduce the amount of an unreacted dye to a level producing no problem in diffusion, bleeding or sublimation.

In the invention, a log P value of one ligand molecule in formula (1) is preferably 3 to 8. Herein, the said one ligand molecule in formula (1) refers to the compound represented by the foregoing formula (2). A log P value falling within this range results in superior stability of a metal chelate dye against heat, light and specifically, water, and a sharp absorption with reduced side absorption, enabling to provide a metal chelate dye exhibiting enhanced solubility in a solvent.

The log P value is a parameter representing a measure of hydrophobicity/hydrophilicity of a compound. A greater value indicates to be more hydrophobic. Reversely, a smaller value indicates to be more hydrophilic. The logP value is a parameter of commonly known compounds, which is measurable or calculable.

A log P value calculated by a calculation equation, as described later, does not completely coincide with a partition coefficient of a material in two solvent systems of n-octanol and water, as defined below, which sometimes produces a slight difference between a calculated value and a measured value. Really different materials sometimes exhibit the same value. However, such a difference is not so large and approximated property can be described in terms of this parameter.
log P=log(Sₒ/S_{w})

Sₒ: solubility of an organic compound in n-octanol at 25° C.

S_{w}: solubility of the organic compound in water at 25° C.

The foregoing is described in detail in Kagaku no Ryoiki, No. 122, “Yakubutsu no Kozokasseisokan (Structure Activity Relation of Pharmaceutical Materials), published by Nanko-do, pages 73-103.

Recently, determination of log P by calculation is proposed, such as a method based on molecular orbital calculation, a fragment method basically employing Hansch's data and a method based on HPLC.

Calculation program of log P usable in the invention is Project Leader in a molecule calculation package, named CAChe, produced by FUJITSU, which is based a fragment method described in A. K. Ghost et al., J. Comput. Chem. 9: 80 (1988). When a log P value is obtainable by calculation, the use of a calculated value is preferred.

Specific examples of the metal containing compound of formula (1) are shown below but are not limited to these.

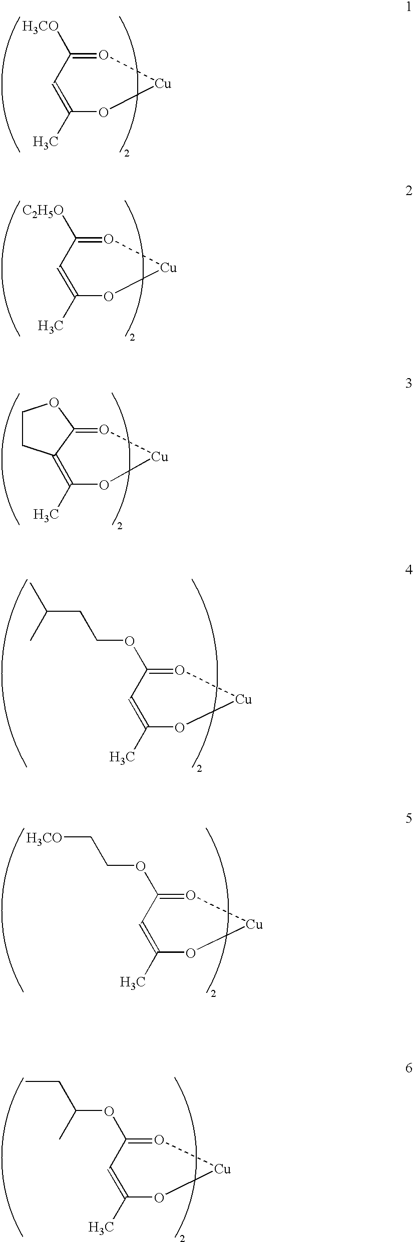

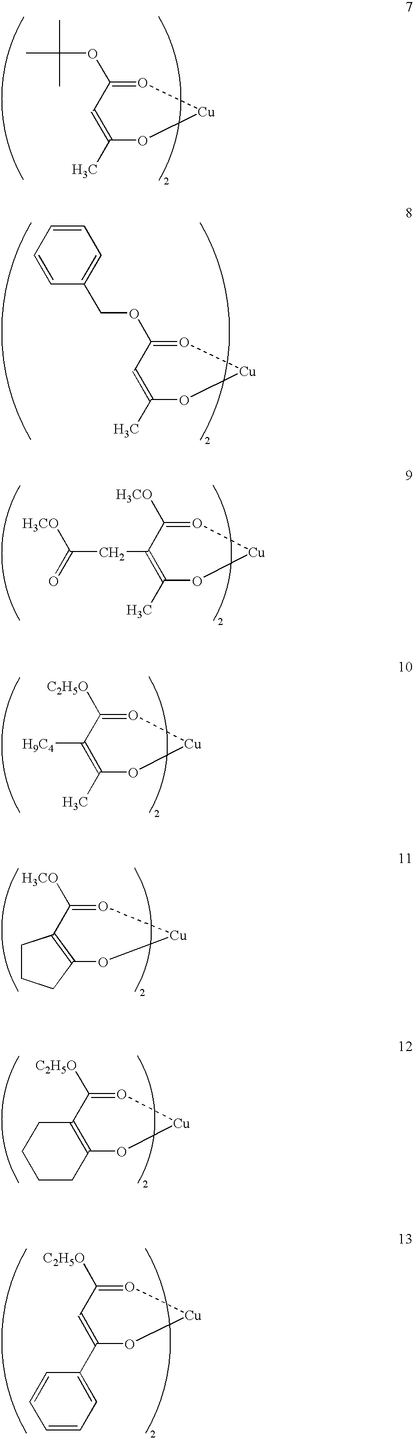

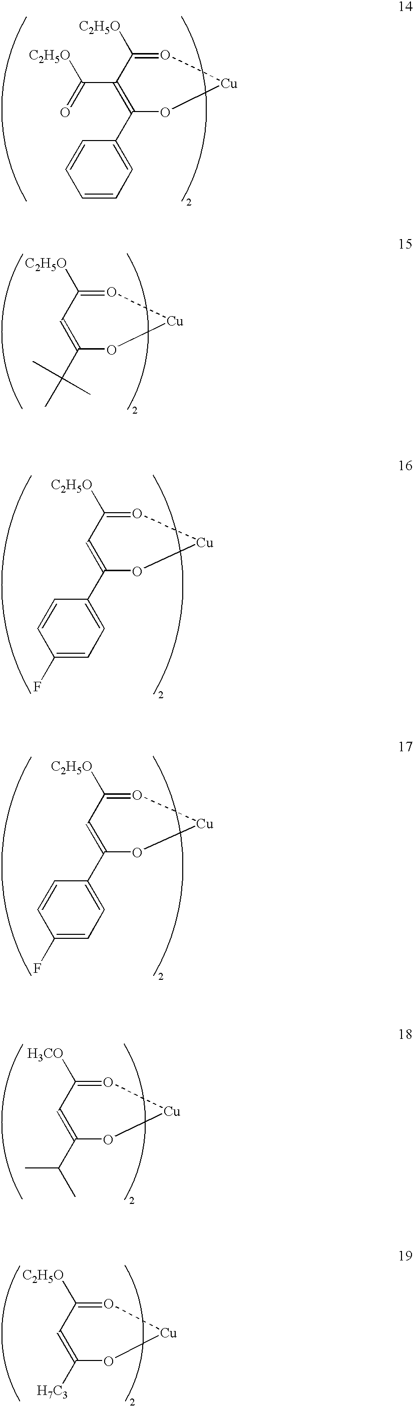

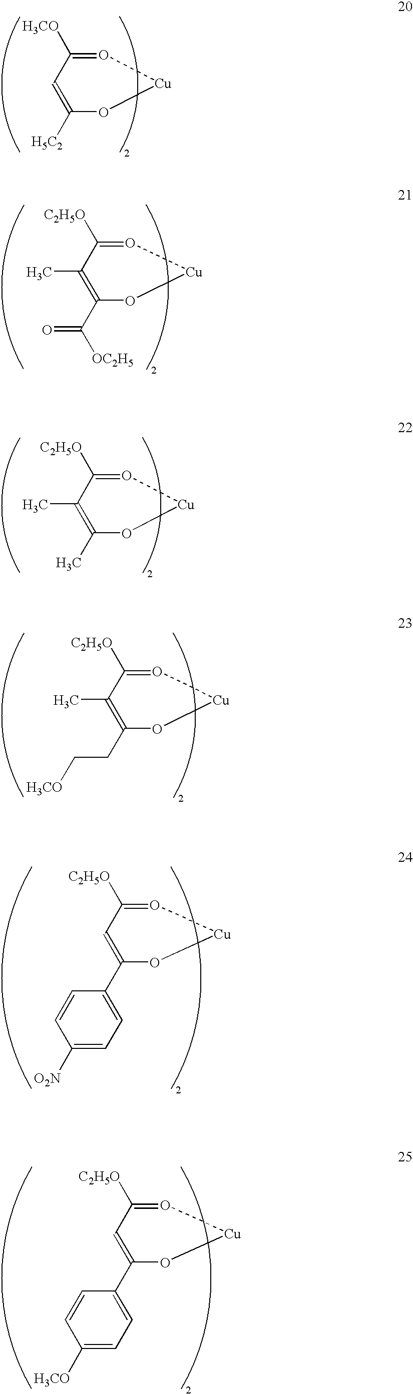

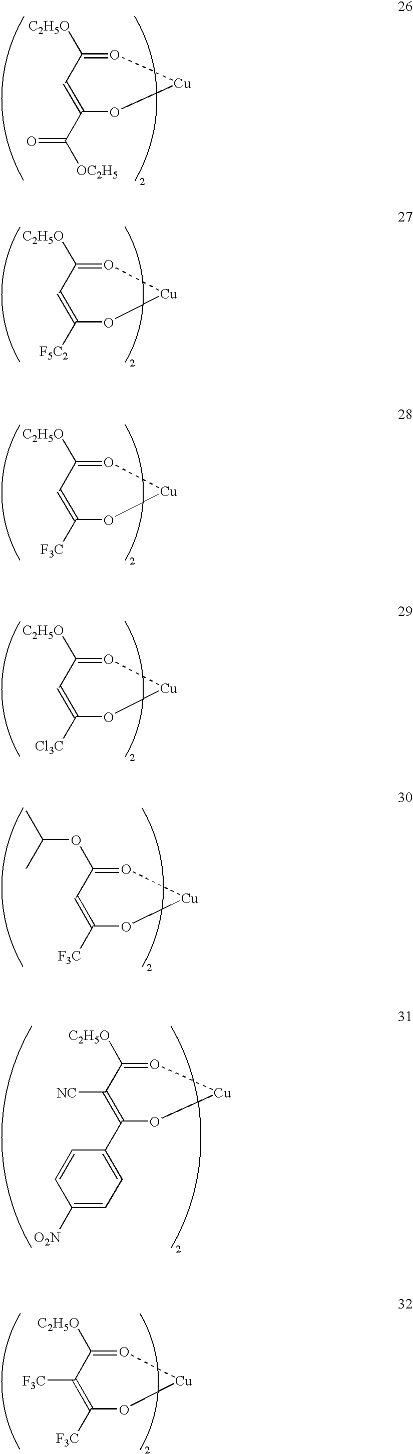

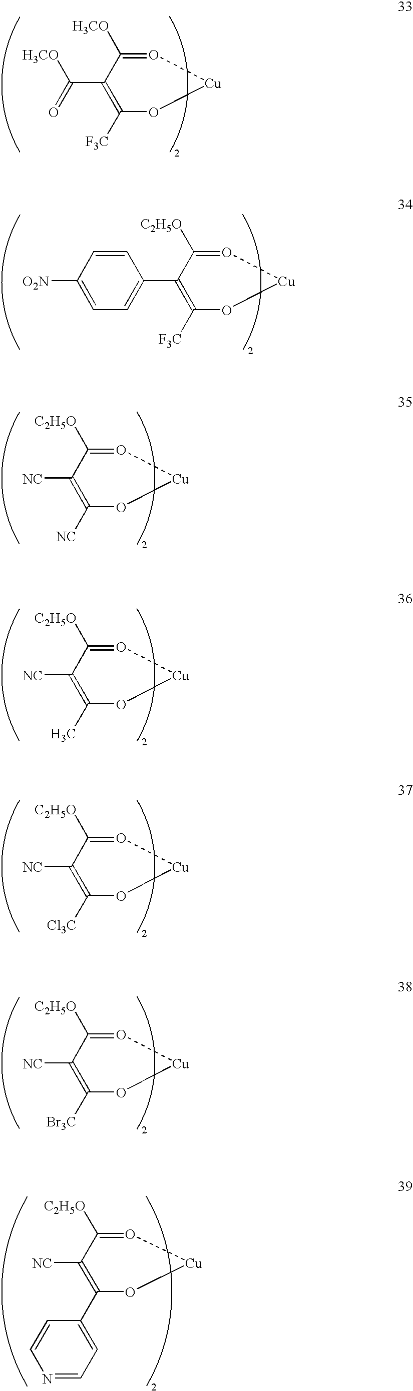

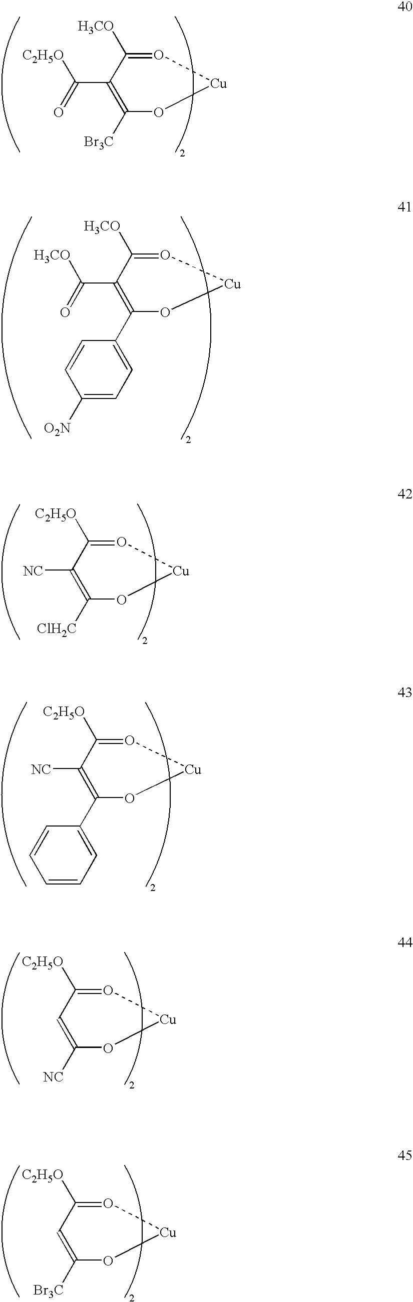

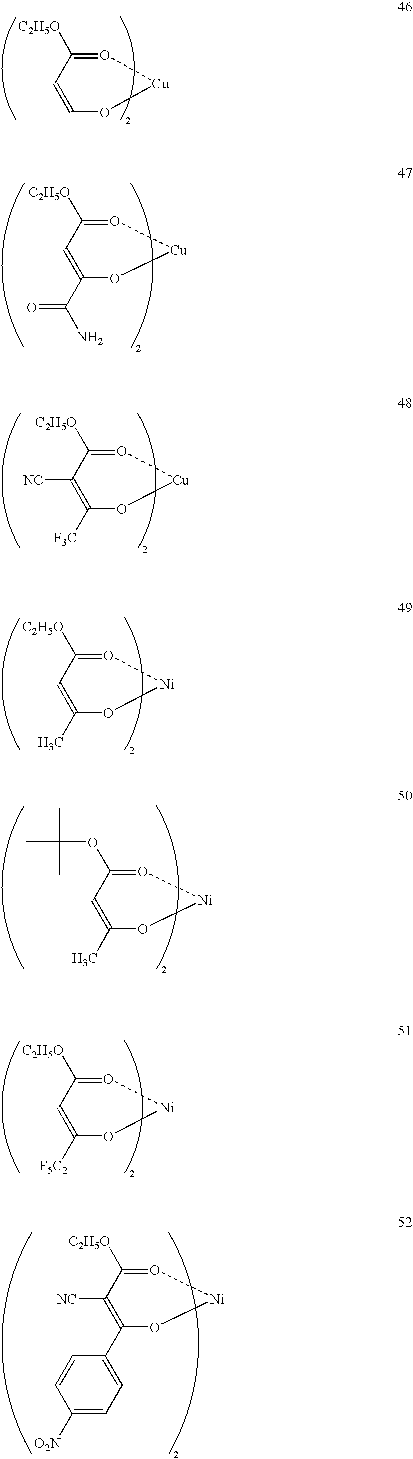

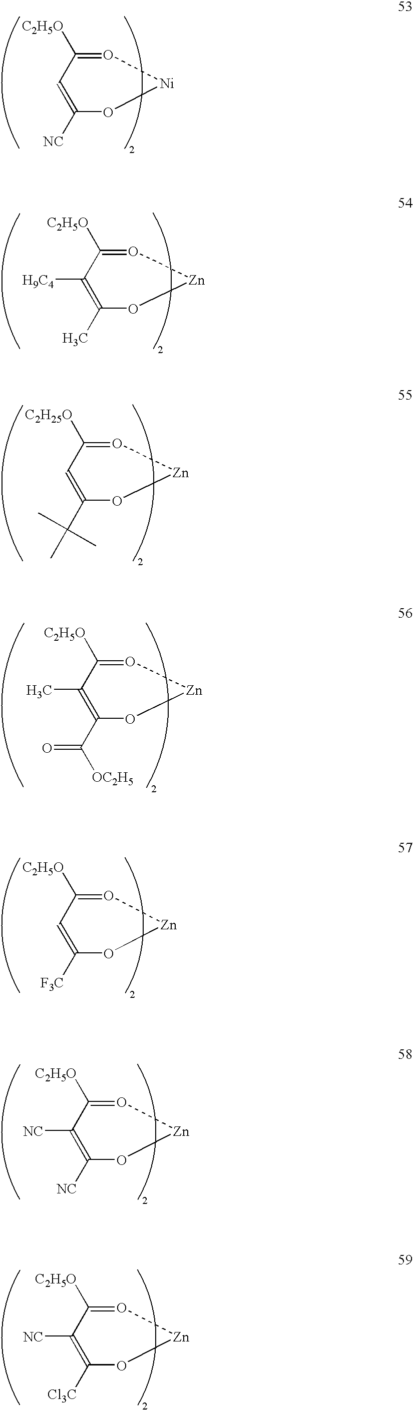

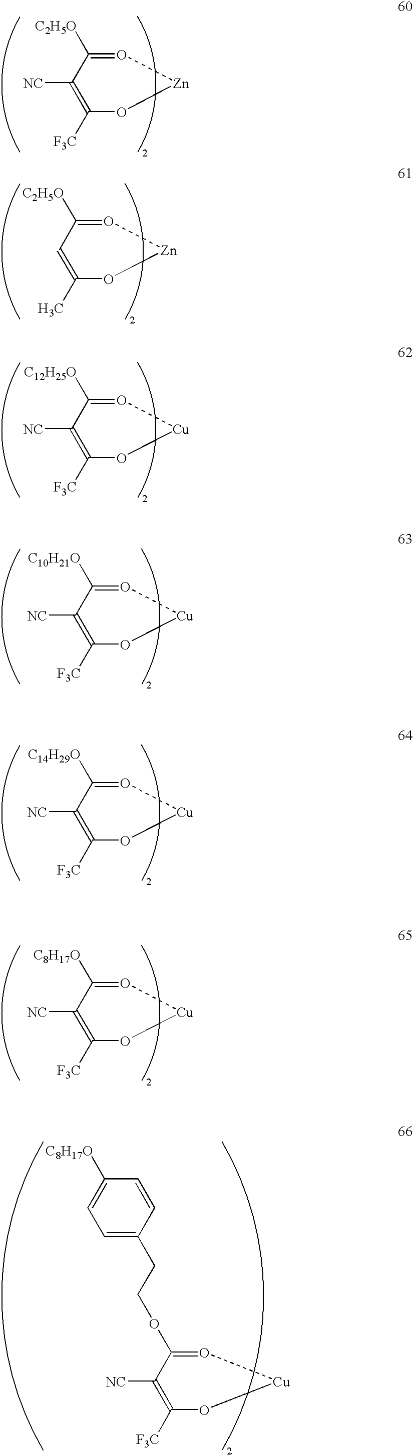

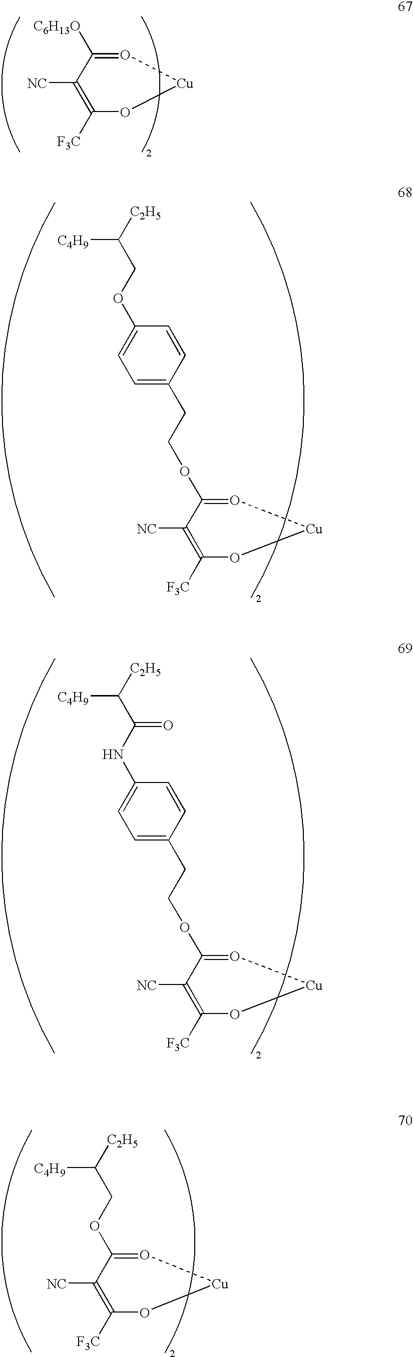

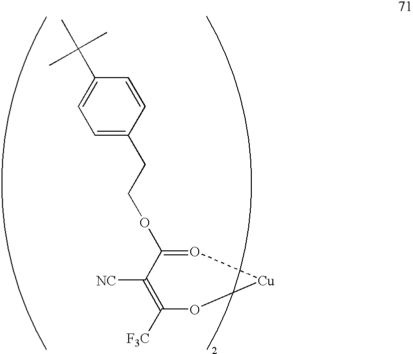

When using the metal containing compound of the invention by addition thereof to an electrophotographic toner, at least one chelatable dye is used. Any dye which is chelatable with the metal containing compound is usable in the invention and examples of such a dye include those described in JP-A Nos. 3-114892, 4-62092, 4-62094, 4-82890, 5-16545, 5-177958 and 5-301470.

A yellow dye is preferably one represented by the following formula (3): 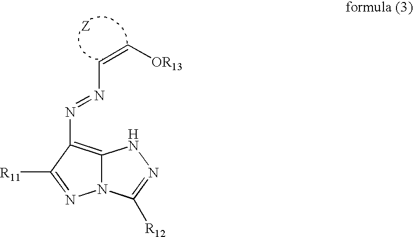
wherein R₁₁ and R₁₂ a hydrogen atom or a substituent; R₁₃ is an alkyl or aryl group, which may be substituted; Z is an atomic group necessary to form a 5- or 6-membered aromatic ring together with two carbon atoms.

Dyes of formula (3) can be prepared, for example, in such a manner that a compound represented by the following formula (A) is subjected to diazotization in accordance with a method described in Chemical Reviews, Vol. 75, 241 (1975) and further subjected a conventional coupling reaction with a compound represented by the following formula (B): 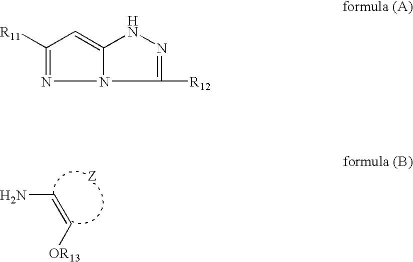
wherein R₁₁, R₁₂, R₁₃ and Z are each the same as defined in the above-defined R₁₁, R₁₂, R₁₃ and Z.

Typical examples of a yellow dye of formula (3) are shown below but are by no means limited to these.

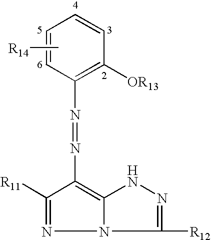

| Compound No. | R₁₁ | R₁₂ | R₁₃ | R₁₄ |
|---|---|---|---|---|
| Y-1 | —CH₃ | —C₄H₉ | —CH₃ | — |
| Y-2 | —C₃H₇(i) | 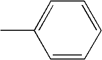 | —CH₃ | — |
| Y-3 | —C₃H₇(i) | —C₂H₅ | —CH₃ | — |
| Y-4 | —CH₃ | —C₂H₅ | —CH₃ | — |
| Y-5 | —C₃H₇(i) | 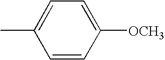 | —CH₃ | 4-Cl |
| Y-6 | —C₃H₇(i) | —C₂H₅ | —CH₃ | 4-CO₂CH₃ |
| Y-7 | —C₃H₇(i) | —C₄H₉ | —CH₃ | 5-CO₂CH₃ |
| Y-8 | —C₄H₉(t) | —C₄H₉ | —CH₃ | — |
| Y-9 | —C₃H₇(i) | 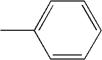 | —C₃H₇(i) | — |
| Y-10 | —C₃H₇(i) | 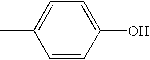 | —CH₃ | — |
| Y-11 | —C₃H₇(i) | —C₃H₇ | —CH₃ | 5-Cl |
| Y-12 | —C₃H₇(i) | 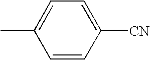 | —CH₃ | — |
| Y-13 | —C₄H₉(t) | 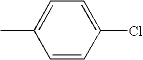 | —CH₃ | — |
| Y-14 | —SCH₃ | 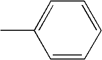 | —CH₃ | — |
| Y-15 | 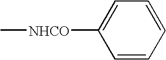 | —C₂H₅ | —CH₃ | — |
| Y-16 | 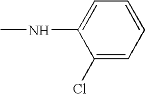 | —C₂H₅ | —CH₃ | — |
| Y-17 | —OCH₃ | —C₄H₉ | —CH₃ | — |
| Y-18 | —C₄H₉(t) | —C₄H₉ | —CH₃ | 4-CO₂H |
| Y-19 | —C₃H₇(i) | 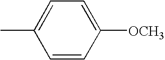 | —CH₃ | — |
| Y-20 | —C₃H₇(i) | 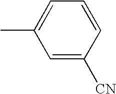 | —CH₃ | — |
| Y-24 | —C₃H₇(i) | —C₂H₅ | —CH₃ | 5-Cl |
| Y-25 | —C₄H₉(t) | —C₄H₉ | —CH₃ | 5-Cl |
| Y-26 | —C₄H₉(t) | —C₂H₅ | —CH₃ | 5-Cl |
| Y-27 | —C₄H₉(t) | 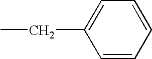 | —CH₃ | 5-Cl |
| Y-28 | —C₄H₉(t) | 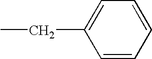 | —CH₃ | — |
| Y-29 | —C₄H₉(t) | 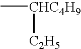 | —CH₃ | 5-Cl |
| Y-30 | —C₄H₉(t) | —C₅H₁₃ | —CH₃ | 5-Cl |
| Y-31 | —C₄H₉(t) | —CH₃ | —CH₃ | 5-Cl |
| Y-32 | —C₄H₉(t) | —CH₃ | —CH₃ | — |

| | |
|---|---|
| Y-21 | 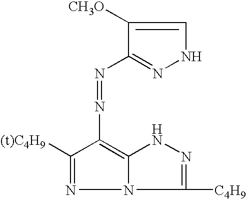 |
| Y-22 | 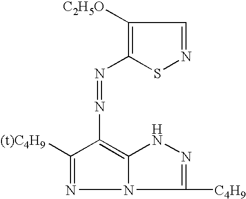 |
| Y-23 | 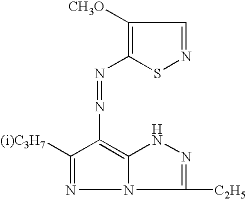 |

A magenta dye is preferably one represented by the following formula (4): 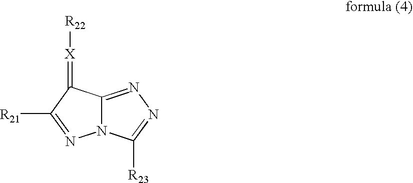
wherein R₂₁ is a hydrogen atom, a halogen atom or a substituent; R₂₂ is an aromatic carbocycle or aromatic heterocycle group, which may be substituted; X is a methine group or a nitrogen atom; R₂₃ is represented by the following formula (5) or (6), in which X′ is a carbon atom or a nitrogen atom, Y is an atomic group necessary to form a nitrogen-containing aromatic heterocycle, W is an atomic group necessary to form an aromatic carbocycle or an aromatic heterocycle, and R₂₄ is an alkyl group:

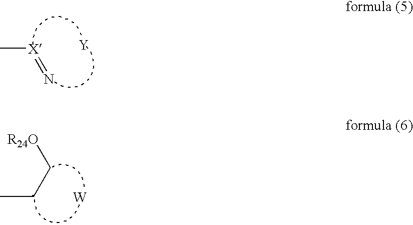

Dyes of formula (4) can be synthesized by methods known in the art. For instance, an azomethine dye of formula (4) can be synthesized in accordance with an oxidation coupling method described in JP-A Nos. 63-113077, 3-275767 and 4-89287.

Specific examples of the dye of formula (4) are shown below but are by no means limited to these.
Substituent R₂₁ 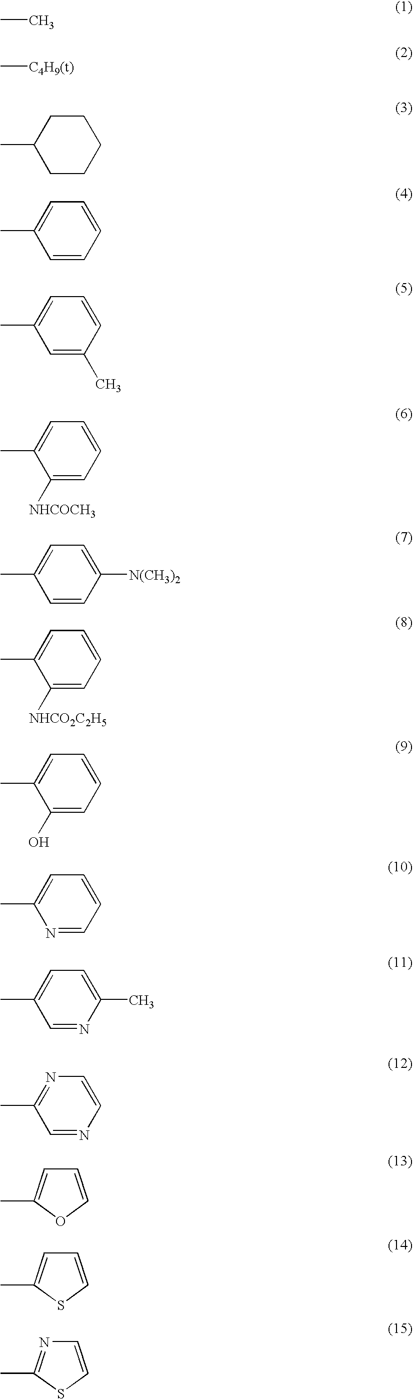 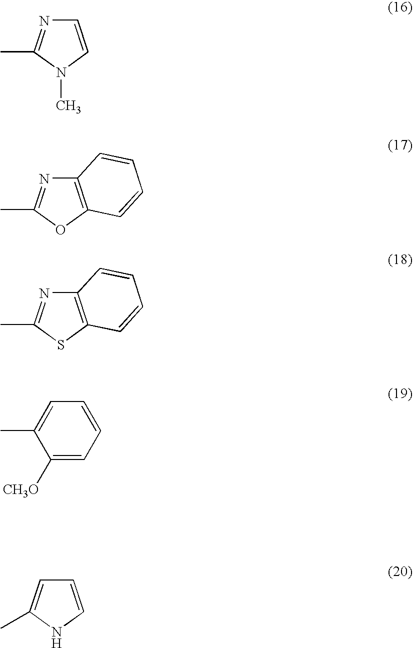
Substituent R₂₂

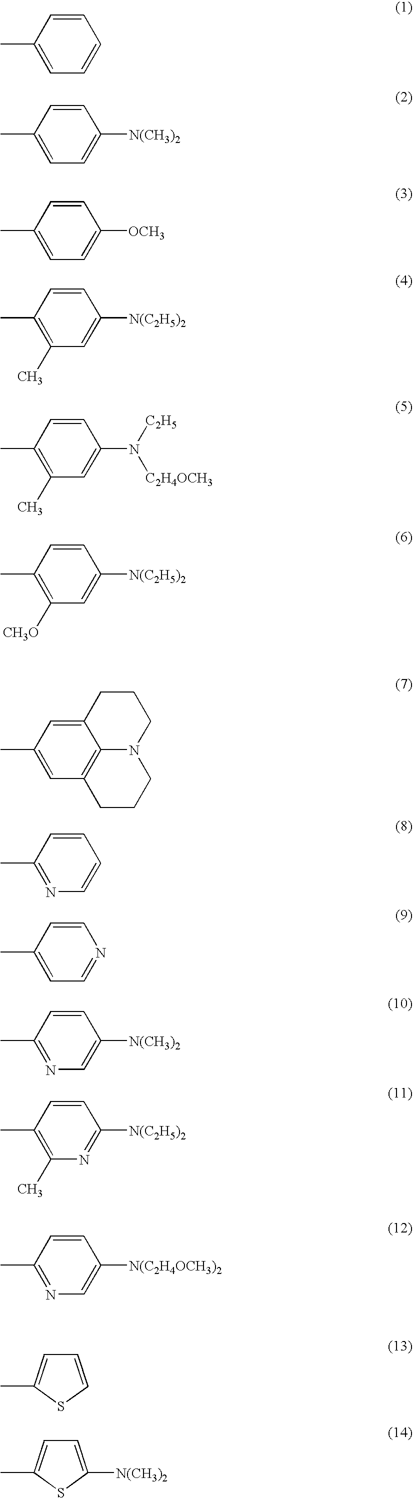

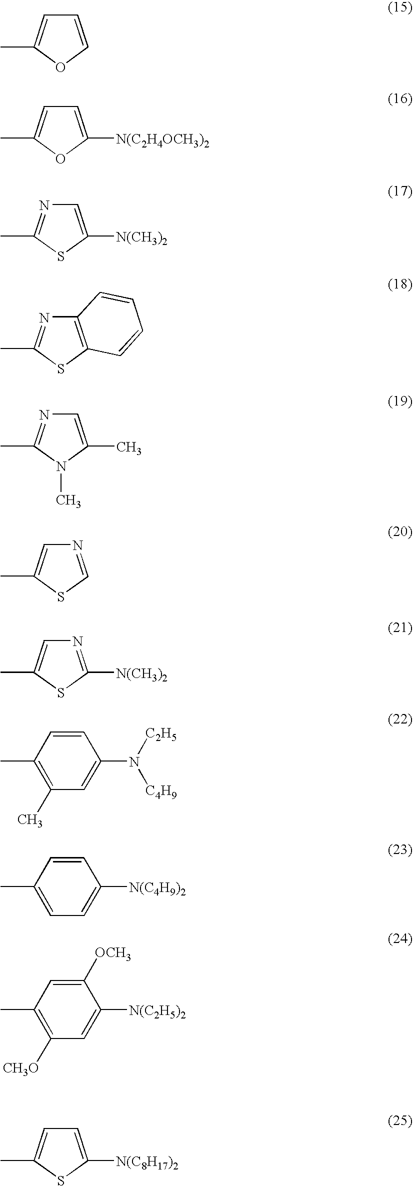

Substituent R₂₃

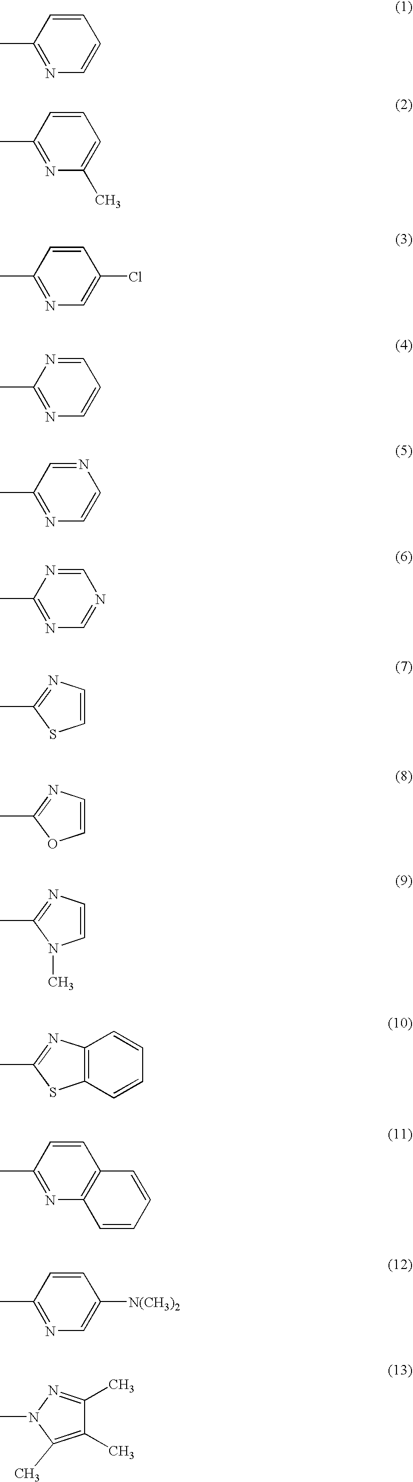

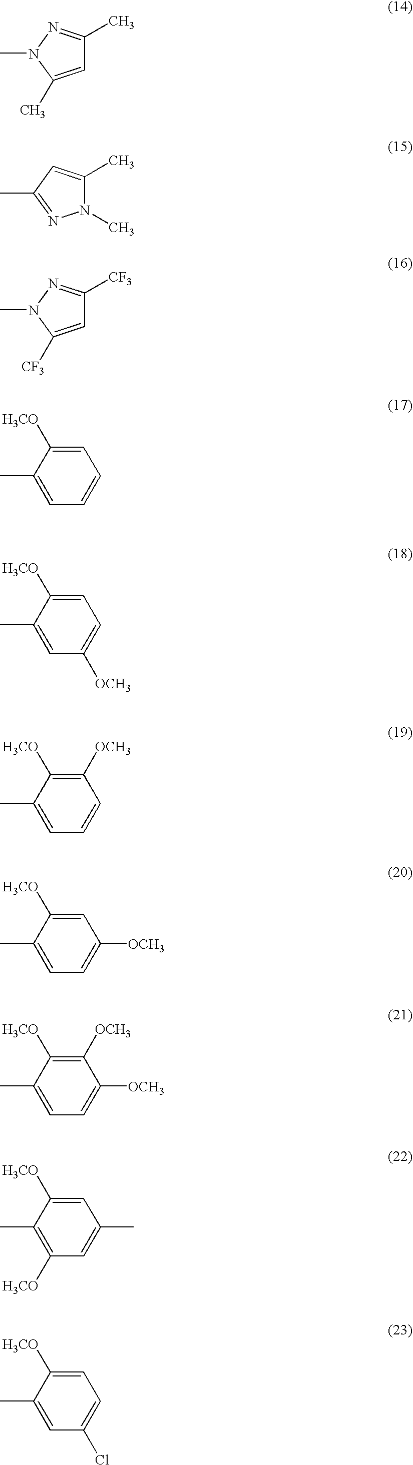

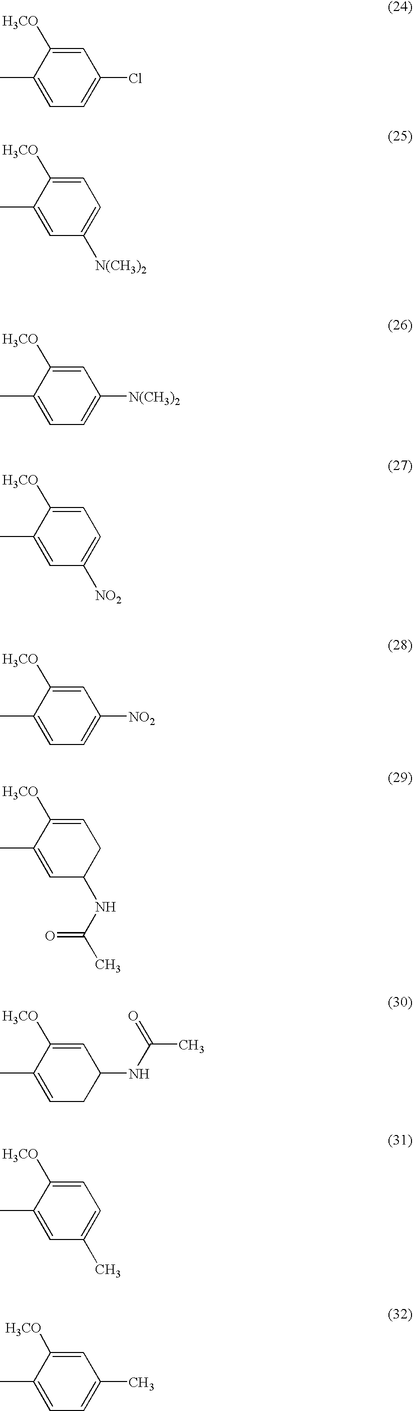

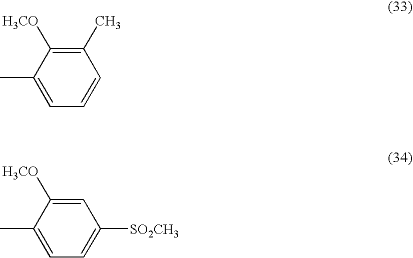

| Dye | R₂₁ | R₂₂ | R₂₃ | X |
|---|---|---|---|---|
| M-1 | (1) | (2) | (15) | N |
| M-2 | (1) | (6) | (9) | N |
| M-3 | (1) | (6) | (10) | N |
| M-4 | (1) | (11) | (7) | N |
| M-5 | (1) | (11) | (8) | N |
| M-6 | (1) | (17) | (8) | CH |
| M-7 | (1) | (20) | (6) | CH |
| M-8 | (1) | (21) | (7) | CH |
| M-9 | (2) | (4) | (3) | N |
| M-10 | (2) | (4) | (5) | N |
| M-11 | (2) | (4) | (6) | N |
| M-12 | (2) | (8) | (3) | CH |
| M-13 | (2) | (10) | (4) | CH |
| M-14 | (2) | (11) | (1) | N |
| M-15 | (2) | (13) | (15) | CH |
| M-16 | (2) | (14) | (1) | CH |
| M-17 | (2) | (14) | (4) | N |
| M-18 | (2) | (19) | (5) | CH |
| M-19 | (3) | (5) | (2) | N |
| M-20 | (3) | (16) | (9) | CH |
| M-21 | (3) | (18) | (10) | CH |
| M-22 | (4) | (3) | (2) | CH |
| M-23 | (4) | (3) | (14) | N |
| M-24 | (4) | (7) | (13) | N |
| M-25 | (4) | (10) | (11) | N |
| M-26 | (4) | (13) | (12) | CH |
| M-27 | (4) | (15) | (11) | CH |
| M-28 | (5) | (9) | (14) | CH |
| M-29 | (5) | (12) | (13) | CH |
| M-30 | (5) | (21) | (12) | N |
| M-31 | (10) | (2) | (15) | N |
| M-32 | (16) | (13) | (15) | CH |
| M-33 | (17) | (18) | (15) | N |
| M-34 | (18) | (21) | (15) | CH |
| M-35 | H | (7) | (16) | CH |
| M-36 | H | (16) | (16) | N |
| M-37 | (2) | (4) | (5) | CH |
| M-38 | (2) | (22) | (5) | CH |
| M-39 | (2) | (25) | (18) | CH |
| M-40 | (1) | (25) | (17) | CH |
| M-41 | (4) | (25) | (17) | CH |
| M-42 | (4) | (22) | (17) | CH |
| M-43 | (4) | (22) | (28) | CH |
| M-44 | (2) | (14) | (18) | CH |
| M-45 | (2) | (25) | (25) | CH |

are each an alkyl group

A cyan dye is preferably one represented by the following formula (6): 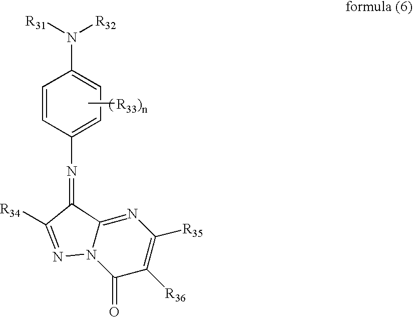
wherein R₃₁ and R₃₂ are each a substituted or unsubstituted aliphatic group; R₃₃ is a substituent; n is an integer of 0 to 4, provided that when n is 2 or more, plural R₃₃s may be the same or different; R₃₄, R₃₅ and R₃₆ are each an alkyl group, which may be the same or different, provided that R₃₅ and R₃₆ are each an alkyl group having 3 to 8 carbon atoms.

Dyes of formula (6) can be synthesized by methods known in the art, for instance, in accordance with an oxidation coupling method described in JP-A Nos. 2000-2255171, 2001-334755 and 2002-234266.

Specific examples of the dye of formula (6) are shown below but are by no means limited to these.

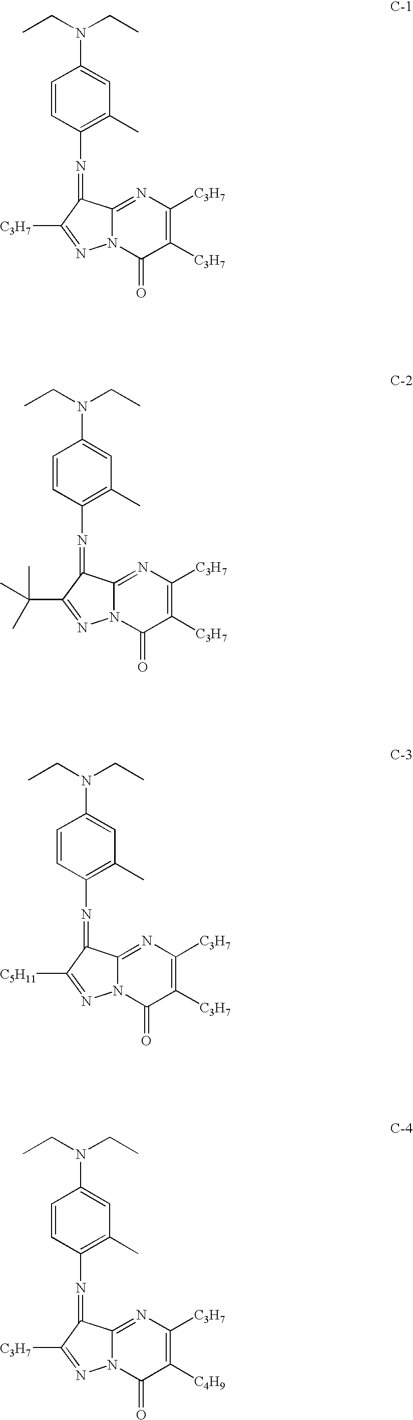

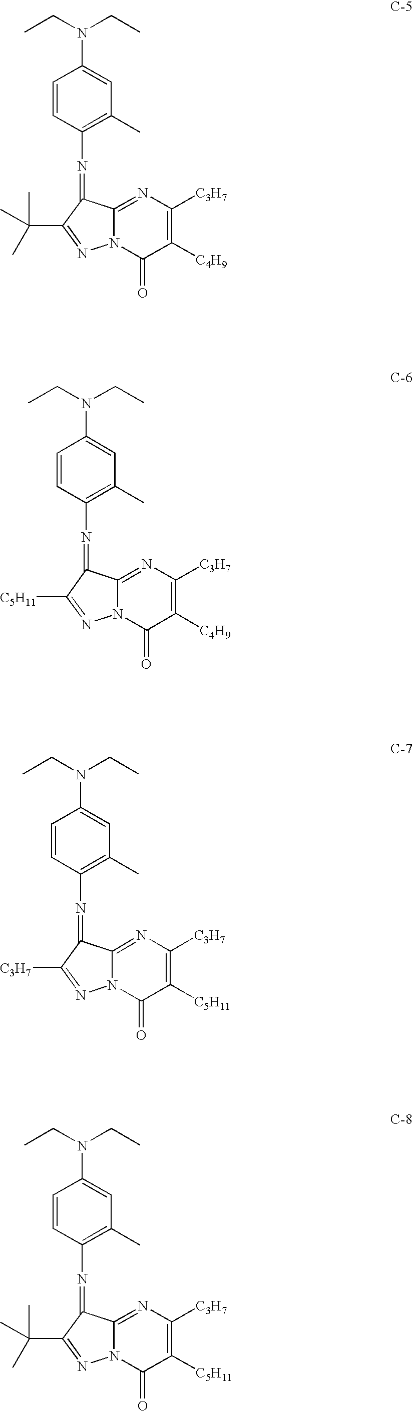

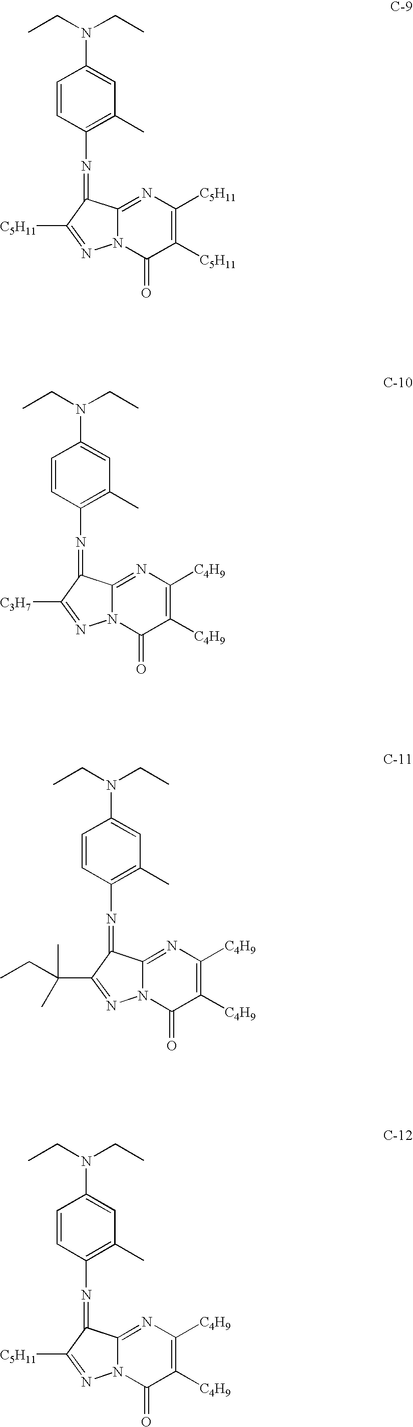

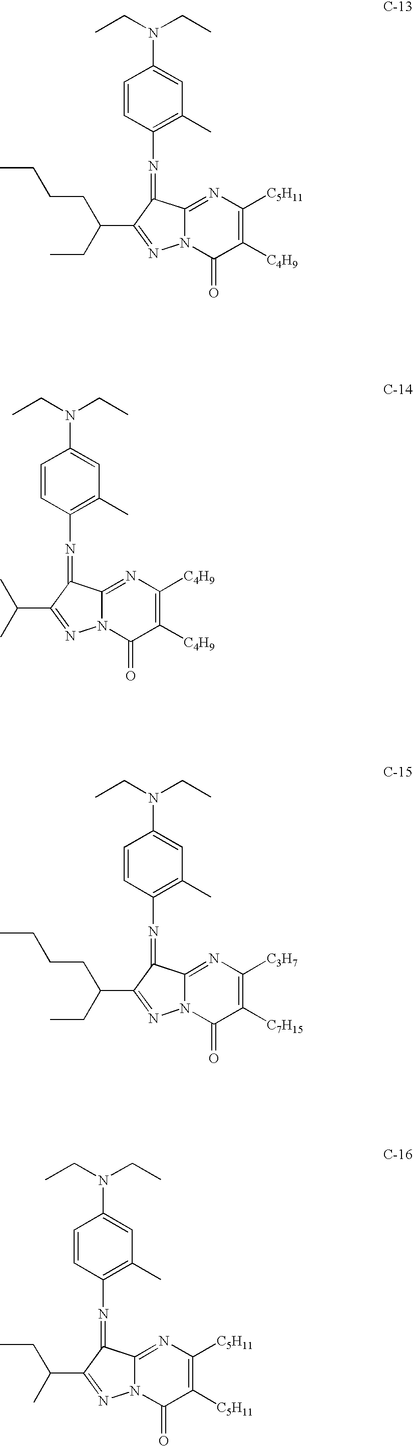

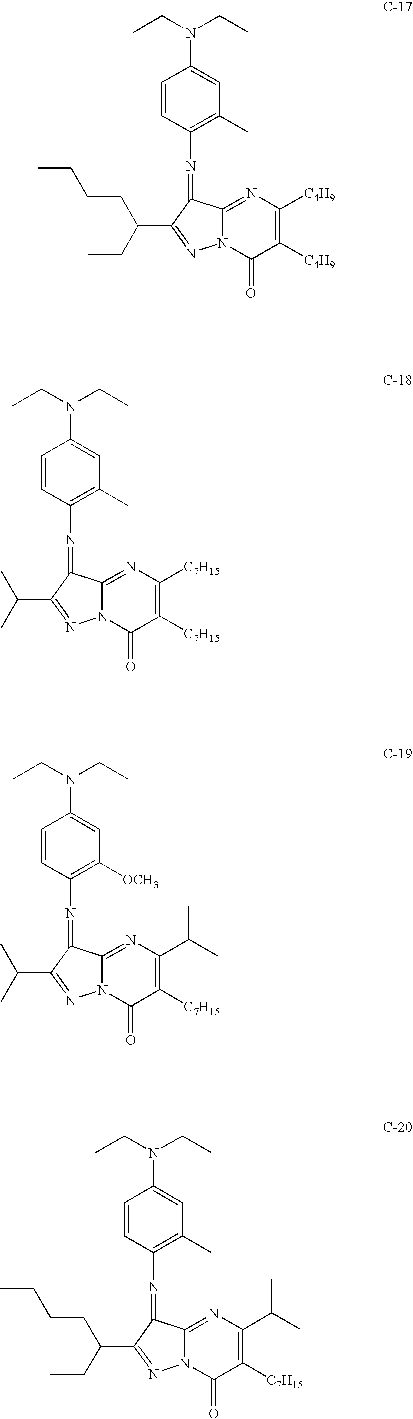

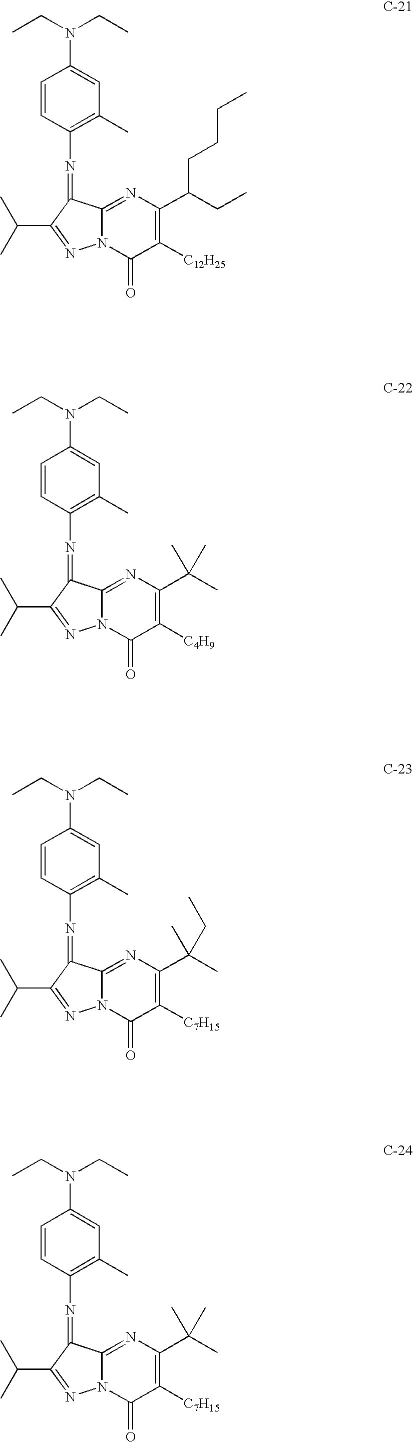

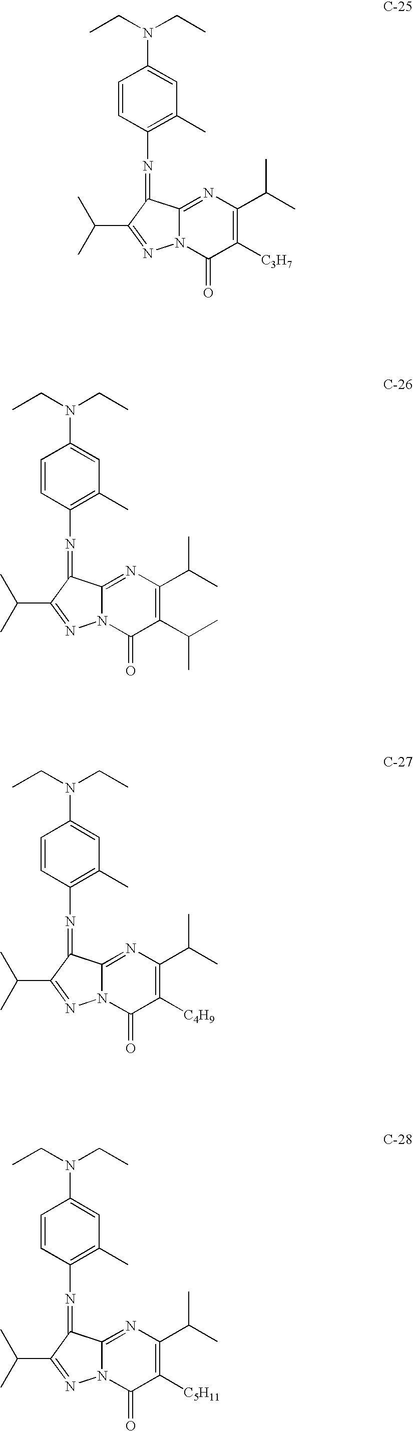

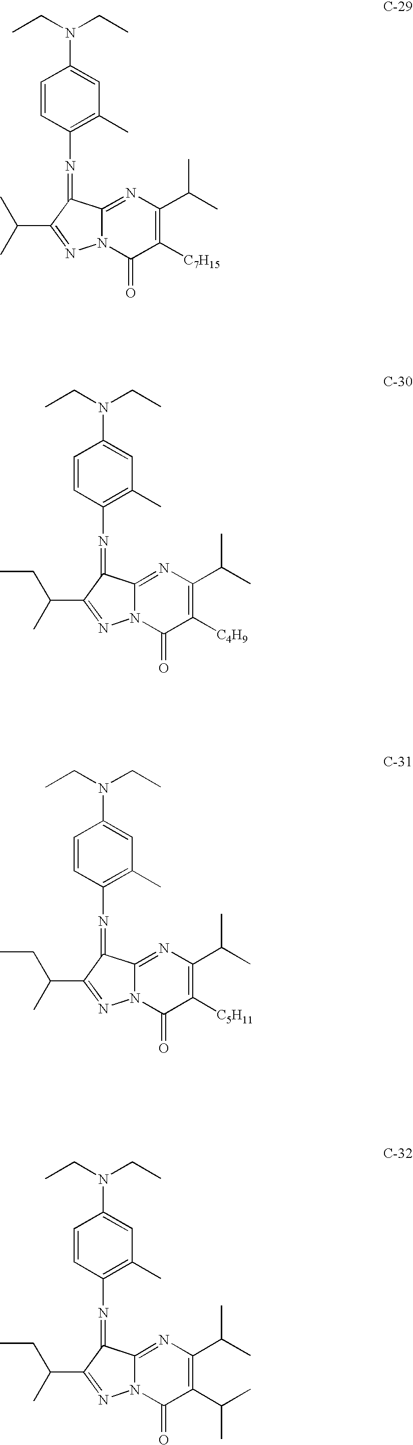

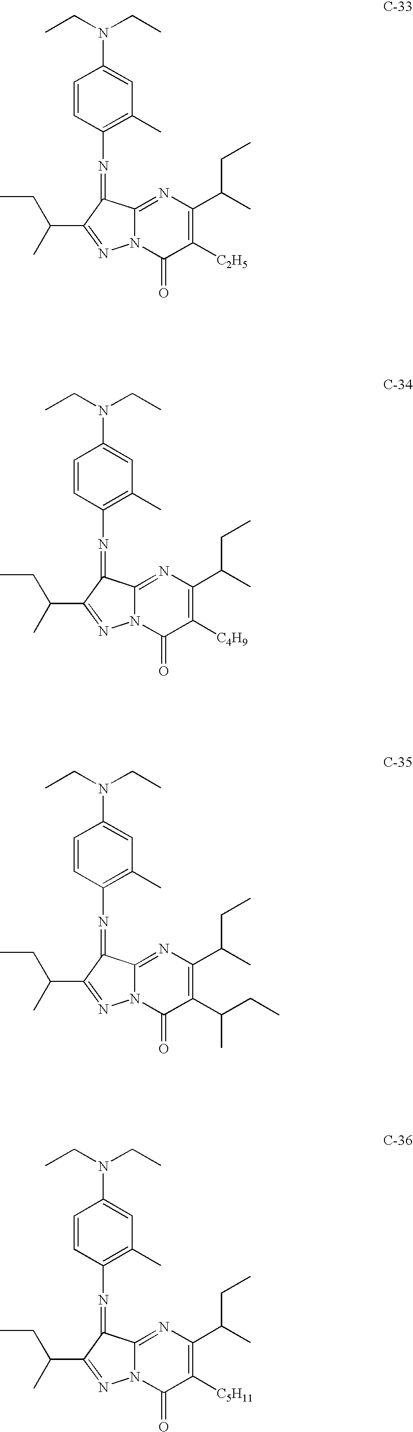

A metal chelate dye comprised of the metal containing compound of formula (1) and the dye of formula (3), (4) or (6) is represented by the following formula (7), (8) or (9): 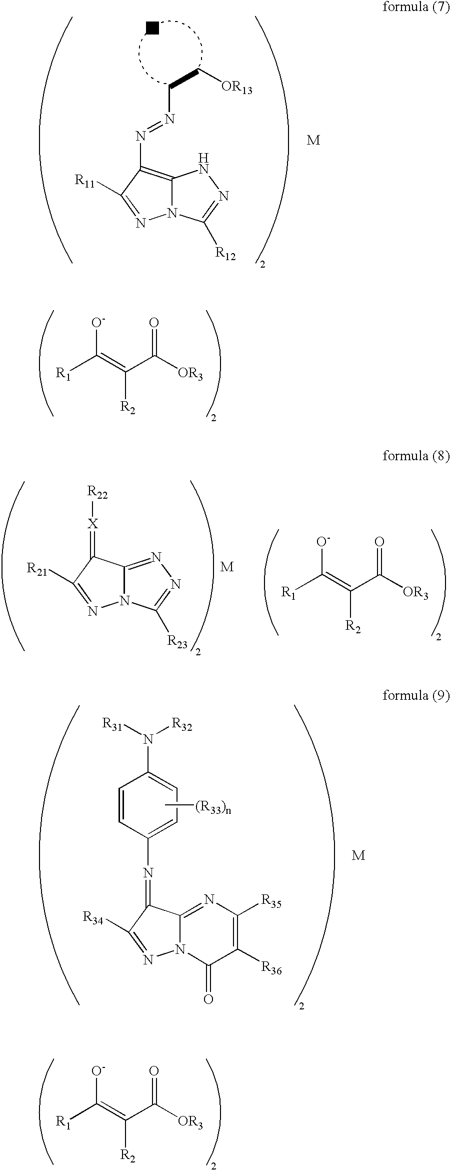
wherein R₁₁, R₁₂, R₁₃, R₂₁, R₂₂, R₂₃, R₃₁, R₃₂, R₃₃, R₃₄ and R₃₅ are each the same as defined in the foregoing formulas (3), (4), (5) and (6); R₁, R₂ and R₃ are each the same as defined in the foregoing formula (1); and M is a divalent metal ion.

The toner of the invention is preferably comprised of a resin in which a metal chelate dye composed of the metal containing compound of formula (1) and a dye capable of chelating with the metal containing compound is dispersed in the form of solid particles. The metal chelate due can be dispersed in a resin in the form of solid particles, for example, in the manner as follows.

A mixture of a metal containing compound of formula (1) and a dye capable of chelating with the metal containing compound, or a mixture of a metal containing compound of formula (1), a dye capable of chelating with the metal containing compound and a resin is dissolved (or dispersed) in a water-immiscible organic solvent such as ethyl acetate or toluene and further emulsified in water to form an emulsion; the thus formed emulsion is subjected to submerged drying to remove the organic solvent to obtain a dispersion of colored particles; and the colored particles are allowed to coagulate with a latex of a (thermoplastic) resin to obtain toner particles. Emulsification is carried out using, for example, an ultrasonic homogenizer or a high-speed stirring type disperser.

A solid particle dispersion of the metal chelate dye is comprised of microparticles, preferably having a particle size of 10 to 10 nm (more preferably 10 to 80 nm. The solid particle dispersion is preferably comprised of monodisperse microparticles, whereby light-scattering is reduced and light-masking particles are reduced. Enhanced monochromatic transparency of the toner results, leading to greatly enhanced chroma (or colorfulness) per dye coverage.

Alternatively, a solid metal chelate dye is mixed with a solid surfactant and pulverized by using a medium type stirrer to obtain a dispersion of colored particles. The colored particle dispersion is allowed to coagulated with a latex of (thermoplastic) resin to obtain toner particles.

A solid particle dispersion obtained by the submerged drying method is comprised of particles exhibiting a form close to a sphere, resulting in enhanced adhesiveness to a binder and reduced interfacial scattering.

Conventional anionic emulsifiers (surfactants) and/or nonionic emulsifiers (surfactants) are optionally employed in emulsification of the metal chelate dye. Example of nonionic emulsifiers include polyoxyethylene alkyl ethers such as polyoxyethylene lauryl ether and polyoxyethylene stearyl ether; polyoxyethylene alkylphenyl ethers such as polyoxyethylene nonylphenyl ether; sorbitan higher fatty acid esters such as sorbitan monolaurate, sorbitan monostearate and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and block copolymers of polyoxyethylene-polyoxypropylene. Examples of anionic emulsifiers include higher fatty acid salts such as sodium oleate; alkylarylsulfonates such as sodium dodecylbenzenesulfonate; alkylsulfuric acid esters such as sodium laurylsulfate; polyoxyethylene alkyl ether sulfuric acid esters such as polyethoxyethylene lauryl ether sulfuric acid sodium salt; polyoxyethylene alkylaryl ether sulfuric acid ester salts such as polyoxyethylene nonyl phenyl ether sulfuric acid sodium salt; and alkyl sulfosuccinic acid ester salts such as sodium monooctylsulfosuccinate, sodium dioctylsulfosuccinate and polyoxyethylene laurylsulfosuccinic acid sodium salt.

A metal chelate dye included in the electrophotographic toner of the invention preferably is in the form of particles having a particle size of 10 to 100 nm. Metal chelate dye particles preferably are monodisperse, whereby light-scattering is reduced and light-masking particles are removed. When a metal chelate dye is not in the state of a molecule but in the form of coagulated particles, migration is inhibited, causing no concern of sublimation of a dye during fixing or oil staining.

Resin usable in the invention is preferably a thermoplastic resin exhibiting enhanced adherence to colored particles containing the metal chelate dye and solvent-soluble resin is specifically preferred. Such thermoplastic resin is used in the form of a latex. Curable resin capable of forming three-dimensional structure, a precursor of which is oil-soluble, is also preferably used. Any thermoplastic resin which is generally used as a binding resin for toners is usable in the invention. A styrene resin, an acryl resin such as alkyl acrylate or alkyl methacrylate, a styrene-acryl copolymer resin, a polyester resin, a silicone resin, olefin resin, amide resin and an epoxy resin are suitably used. To enhance transparency or color reproduction of overlapped images is desirable a resin exhibiting high transparency and melting characteristics of low viscosity and sharp-melting. Examples of a resin exhibiting such characteristics include a styrene resin, an acryl resin and polyester resin.

The number-average molecular weight (Mn) of a resin used in the invention is preferably in the range of 3,000 to 6,000 and more preferably 3,500 to 5,500. The ratio of weight-average molecular weight (Mw) to number-average molecular weight (Mn), Mw/Mn is preferably in the range of 2 to 6 and more preferably 2.5 to 5.5. The glass transition point of a resin is preferably in the range of 50 to 70° C., and more preferably 55 to 70° C.; and the softening point is preferably 90 to 110° C., and more preferably 90 to 105° C. A number-average molecular weight of a resin of less than 3,000 causes releasing in imaging areas when a full color solid image is bent (deteriorated fixability on bending), and a number-average molecular weight of more than 6,000 results in lowered heat-meltability, leading to reduced fixing strength. A Mw/Mn of less than 2 easily causes high-temperature offset and a Mw/Mn of more than 6 results in deteriorated sharp-melt characteristic, leading to reduced translucence of the toner and deteriorated color-mixing property of a full-color image. A glass transition point of lower than 50° C. results in insufficient heat resistance and easily causing agglomeration of toner particles during storage and a glass transition point of higher than 70° C. renders it difficult to be melted, resulting in deteriorated fixability and deteriorated color-mixing property of a full-color image. A softening point of lower than 90° C. easily causes high-temperature offset and a softening point of higher than 110° C. deterioration in fixing strength, translucence, color-mixing property and glossiness of a full-color image.

The electrophotographic toner of the invention may further contain a charge-controlling agent or offset inhibitor known in the art, in addition to thermoplastic resin, the metal containing compound of formula (1), the dye capable of chelating with the metal containing compound and colored particles containing the metal chelate dye. Charge-controlling agents are not specifically limited and colorless, white or light-colored charge-controlling agents which do not adversely affect color or translucence of the toner are usable as a charge-controlling agent for a color toner. Suitable examples thereof include zinc or chromium metal complexes of salicylic acid derivatives, carixarene compounds, organic boron compounds, and fluorine-containing quaternary ammonium compounds. Specifically, there are usable salicylic acid metal complexes described in JP-A Nos. 53-127726 and 62-145255, carixarene compounds described in JP-A No. 2-201378, organic boron compounds described in JP-A No. 2-221967. A charge-controlling agent is used preferably in an amount of 0.1 to 10 parts by weight per 100 parts by weight of thermoplastic resin (binding resin), and more preferably 0.5 to 5.0 parts by weight. Offset inhibitors usable in the invention are not specifically limited and examples thereof include polyethylene wax, oxidized type polyethylene wax, polypropylene wax, oxidized type polypropylene wax, carnauba wax, sasol wax, rice wax, candelilla wax, jojoba oil wax and bees wax. Such a wax is used preferably in an amount of 0.5 to 5 parts by weight per 100 parts by weight of thermoplastic resin (binding resin), and more preferably 1 to 3 parts by weight. An amount of less than 0.5 part by weight results in insufficient effects and an amount of more than 5 parts by weight results in reduced translucence and deteriorated color reproduction.

The toner of the invention can be prepared through known methods such as a kneading/pulverization method, suspension polymerization, emulsion polymerization, a emulsion granulation method, a capsulation method, using thermoplastic resin (binding resin), the metal containing compound of formula (1), a dye capable of chelating with the metal containing compound and other desired additives. Of the foregoing methods, taking into account reduced toner particle size to achieve high quality image, emulsion polymerization is preferred in terms of manufacturing cost and manufacturing stability.

In the process of emulsion polymerization, a latex of a thermoplastic resin manufactured in emulsion polymerization is mixed with a dispersion of other toner particle constituents such as colored particles. The mixture is gradually coagulated, while maintaining balance between a repulsive force of the particle surface, formed by pH adjustment and a coagulation force due to addition of electrolytes. Association is performed with controlling particle size distribution, while heating to perform fusion of particles and particle size control. The toner particles of the invention are preferably adjusted to a volume-average particle size of 4 to 10 μm, and more preferably 6 to 9 μm to perform high-definition reproduction of images.

Post-treating agents may be added to the toner to provide fluidity or to enhance cleaning ability. Such post-treating agents are not specifically limited and examples thereof include inorganic oxide particles such as silica particles, alumina particles or titania particles; inorganic stearate compound particles such as aluminum stearate particles and zinc stearate particles; and inorganic titanate compound particles such as strontium titanate or zinc titanate, which are used alone or in combination with other additives. Preferably, these particles are subjected to a surface modification treatment using a silane coupling agent, a titanium coupling agent, a higher fatty acid or silicone oil in terms of environment stability or heat-resistant storage stability. Such a surface treatment agent is used preferably in an amount of 0.05 to 5 parts by weight per 100 parts by weight of a toner, and more preferably 0.1 to 3 parts by weight.

The toner of the invention may be mixed with a carrier to be used as two-component toner or may used alone as a single component toner.

Carriers used for conventional two-component toners are usable in combination with the toner of the invention. Examples of such a carrier include a carrier composed of magnetic material particles such as iron or ferrite, resin-coated carrier such as magnetic material particles covered with resin, and a binder type carrier in which powdery magnetic material is dispersed in a binding resin. Of these carriers, a resin-coat carrier which is coated with a silicone resin, a copolymer resin (graft polymer) of an organo-polysiloxane and a vinyl monomer or an ester type resin is preferred in terms of inhibition of spent toner. A carrier covered with a resin which is obtained by reacting an isocyanate with a copolymeric resin of an organo-polysiloxane and a vinyl monomer, is preferred in terms of durability and environment-resistant stability. A monomer having a reactive group capable of reacting with an isocyanate, such as a hydroxyl group is usable as the foregoing vinyl monomer. A carrier preferably has a volume-average particle size of 20 to 100 μm, and more preferably 20 to 60 μm to maintain high image quality and to inhibit carrier fogging.

Chelate dyes used in the invention are applicable to various uses other than the electrophotographic use. Toners can be used in accordance with methods described in JP-A Nos. 20-265690 and 2000-345059. The use of the dyes of the invention or the method of using the dyes are not limited to these.

### EXAMPLES

The invention is further described based on specific examples but are not limited to these embodiments. In the following examples, “part(s)” and “%” each represent parts by weight and % by weight, unless otherwise noted.

### Example 1

In the following, a toner prepared by a pulverization method and a toner prepared by a polymerization method are described, which are hereinafter also denoted simply as a pulverization-type toner and a polymerization-type toner, respectively.

Preparation of Pulverization-Type Color Toner:

100 parts a polyester resin and a mixture of a colorant and a metal containing compound of the invention (molar ratio of 1:1) shown in Table 1 in amounts shown below, were mixed with 3 parts of polypropylene resin (Viscoal 550P, produced by Sanyo Kasei Co., Ltd.) and further subjected kneading, pulverization and classification to obtain a powder having an average particle size of 8.5 μm. 100 parts of the thus obtained powder and 1.0 part of particulate silica R805 (product by Nippon Airogel Co., Ltd., average particle size of 12 nm and a degree of hydrophobicity of 60) was mixed in a Henschel mixer to obtain pulverization color toners of yellow, magenta and cyan.

| | |
|---|---|
| Yellow | 4 parts |
| Magenta | 2 parts |
| Cyan | 2 parts |

Preparation of Polymerization-Type Color Toner 1:
Colorant Dispersion 1:

To a solution of 5 g of sodium dodecylsulfate dissolved in 200 ml of pure water was added 20 g of a mixture of a colorant and a metal containing compound (molar ratio of 1:1) and stirred with providing ultrasonic to prepare an aqueous magenta colorant dispersion 1. A low molecular weight polypropylene (having a number-average molecular weight of 3,200) was dispersed together with a surfactant and emulsified to a low molecular weight polypropylene emulsion of 30% solids.

Color Toner 1:

The thus prepared colorant dispersion 1 was mixed with 60 g of the foregoing low molecular weight polypropylene emulsion. Further thereto, 220 g of styrene, 40 g of butyl acrylate, 12 g of methacrylic acid, 5.4 g of t-dodecylmercaptan as a chain-transfer agent and 2,000 ml of degasses pure water were added and stirred under a nitrogen stream at 70° C. for 3 hr. to perform emulsion polymerization to obtain a dispersion of resin particles containing a colorant.

To 1,000 ml of the obtained colorant-containing resin particle dispersion was added sodium hydroxide to adjust a pH to 7.0 and 270 ml of an aqueous 2.7 mol/l potassium chloride solution was added thereto; further, 160 ml of i-propyl alcohol and 9.0 g of poly(oxyethylene octylphenyl ether) having an average polymerization degree of ethylene oxide, dissolved in 67 ml of pure water was added and stirred for 6 hr. with maintaining at 75° C. to perform reaction. The thus obtained reaction mixture was filtered and washed with water, then, dried and ground to obtain colored particles.

The obtained colored particles was mixed with 1.0 part of particulate silica R805 (above-mentioned) using Henschel mixer to obtain polymerization color toner 1.

Preparation of Polymerization-Type Color Toner 2:

Colorant Dispersion 2:

Into a separable flask were placed 13.5 g of polymer (P-1), 16.0 g of a mixture of a colorant and a metal containing compound of the invention (molar ratio of 1:1), shown in Table 1 and 123.5 g of ethyl acetate. After replacing the interior of the flask with nitrogen, the dye was completely dissolved with stirring. Subsequently, 238 g of an aqueous solution containing 8.0 g of Aqualon KH-05 (produced by Daiich Kogyo Seiyaku Co., Ltd.) was dropwise added with stirring and emulsified over a period of 5 min. by using Clear Mix W-motion CLM-0.8W (produced by M-Technique Co.). Thereafter, ethyl acetate was removed under reduced pressure to obtain a dispersion of colored particles impregnated with a dye.

To the dispersion of colored particles was added 0.5 g of potassium persulfate and heated to 70° C. with a heater. Then, 10.0 g of methyl methacrylate was dropwise added over a period of 5 hr. to perform reaction to obtain colorant dispersion 2 having a core/shell structure.
P-1: copolymer of styrene/2-hydroxyethyl methacrylate/stearyl methacrylate (30/40/30)
   Color Toner 2:

Polymerization-type color toner 2 was obtained similarly to the foregoing color toner 1, except that colorant dispersion 1 was replaced by colorant dispersion 2.

Preparation of Carrier:

40 g of particulate copolymer of styrene/methyl methacrylate (4/6) having an average particle size of 80 nm and 1,960 g of Cu—Zn ferrite particles (having a specific gravity of 5.0, a mass-average particle size of 45 μm and exhibiting a saturation magnetizationof 62 emu/g when an external magnetic field of 1,000 oersted was applied) were placed into a high-speed stirring type mixer and mixed at 30° C. for 15 min. After set to 150° C., a mechanical impact force was repeatedly provided thereto over a period of 30 min. and after cooled, a carrier was obtained.

Preparation of Developer

Using a V-type mixer, 214 g of the foregoing carrier and 16 of each of the toners were mixed for 20 min. to prepare developers 2-1 to 2-18 used for practical picture test. The developer composition is shown in Table 1.

TABLE 1

| | Metal-containing | | | | Preparation |
|---|---|---|---|---|---|
| Developer | Compound | | | | Method of |
| No. | No. | logP | M²⁺ | Colorant | Toner |
| 2-1 (Inv.) | 2 | −0.13 | Cu²⁺ | Y-31 | Pulv. |
| 2-2 (Inv.) | 2 | −0.13 | Cu²⁺ | M-39 | Pulv. |
| 2-3 (Inv.) | 2 | −0.13 | Cu²⁺ | C-27 | Pulv. |
| 2-4 (Inv.) | 13 | 1.67 | Cu²⁺ | Y-31 | Polm. 1 |
| 2-5 (Inv.) | 35 | 0.24 | Cu²⁺ | M-39 | Polm. 1 |
| 2-6 (Inv.) | 49 | −0.10 | Ni²⁺ | C-27 | Polm. 1 |
| 2-7 (Inv.) | 48 | 1.12 | Cu²⁺ | Y-31 | Polm. 2 |
| 2-8 (Inv.) | 48 | 1.12 | Cu²⁺ | M-39 | Polm. 2 |
| 2-9 (Inv.) | 48 | 1.12 | Cu²⁺ | C-27 | Polm. 2 |
| 2-10 (Inv.) | 63 | 4.53 | Cu²⁺ | Y-31 | Polm. 2 |
| 2-11 (Inv.) | 63 | 4.53 | Cu²⁺ | M-39 | Polm. 2 |
| 2-12 (Inv.) | 63 | 4.53 | Cu²⁺ | C-27 | Polm. 2 |
| 2-13 (Comp.) | — | — | — | C.I. P-Y | Pulv. |
| 2-14 (Comp.) | — | — | — | C.I. P-R | Polm. 1 |
| 2-15 (Comp.) | — | — | — | C.I. P-B | Polm. 2 |
| 2-16 (Comp.) | — | — | — | Compound A | Polm. 2 |
| 2-17 (Comp.) | MS-1 | 1.75 | Ni²⁺ | M-38 | Polm. 1 |
| 2-18 (Comp.) | MS-2 | 0.26 | Cu²⁺ | C-27 | Polm. 2 |

CIP-Y: C.I. Pigment Yellow 10
CIP-R: C.I. Pigment Red 57:1
CIP-B: C.I. Pigment Blue 1
Pulv.: pulverization method
Polm. 1: polymerization method 1
Polm. 2: polymerization method 2

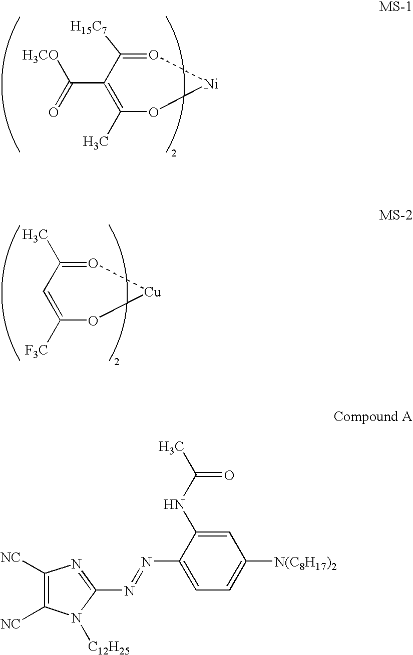 Image Formation:

Practical picture evaluation was conducted using a color copier (KL-2010, produced by Konica Minolta Corp.) as an imaging apparatus.

A fixing apparatus of usually used heat-roll fixing system was used was used. Specifically, the surface of a cylindrical aluminum-alloy core bar having an inside diameter of 40 mm, a wall thickness of 1.0 mm and an overall width of 310 mm), provided with a heater built in the central portion and was covered with a 120 μm thick tube of a copolymer of tetrafluoroethylene and perfluoroalkyl vinyl ether (PFA) to constitute a heating roller; the surface of a cylindrical iron core bar (having an inside diameter of 40 mm and a wall thickness of 2.0 mm) was covered with a sponge-form silicone rubber (having an asker C hardness of 48 and a thickness of 2 mm) to constitute a pressure roller; and the heating roller and the pressure roller were connected under a load of 150 N to form a nip with a width of 5.8 mm.

Using this fixing apparatus, the linear print-speed was set to 480 mm/s. A supply system of a web-system impregnated with polydiphenylsilicone (exhibiting a viscosity of 10 Pa·s at 20° C.) was employed as a cleaning system. The fixing temperature was controlled through the surface temperature of the heating roller. The coating amount of silicone oil was 0.1 mg/A4.

Image Evaluation:

Using the foregoing imaging apparatus and on paper and OHP, a reflection image (image on paper) and a transmission image (OHP image) were formed and evaluated according to the following procedure. Evaluation was made within a toner coverage range of 0.7+0.05 (mg/cm²).

Transparency:

Using 330 type self-registering spectrophotometer (produced By Hitachi Seisakusho), the visible spectral transmittance of an image was measured using an OHP sheet having no toner as reference to determine transmittances at 570 nm (yellow), 650 nm (magenta) and 500 nm (cyan) to evaluate transparency of an OHP image.

Lightfastness:

Using Xenon Long-life Weather-meter, produced by Suga Shikenki Co., Ltd. (a xenon arc lamp of 70,000 lux, 24.0 C), exposure test was conducted over a period of 7 days. Using Macbeth Color-Eye 7000, the color difference between before and after subjected to the exposure test was determined.

Heat Resistance (Sublimeness)

The fixing roller and recovered silicone oil were observed and the level of coloring was visually evaluated based on the following criteria:
A: no coloring was observed in the fixing roller and silicone oil,
B: coloring of the fixing roller and silicone oil was observed.

The obtained results are shown in Table 2.

TABLE 2

| | | | Heat |
|---|---|---|---|
| | Transparency (OHP | Lightfastness | |
| Developer No. | transmittance, %) | (ΔE) | (sublimeness) |
| 2-1 (Inv.) | 70.2 | 0.4 | A |
| 2-2 (Inv.) | 69.1 | 0.6 | A |
| 2-3 (Inv.) | 67.9 | 0.7 | A |
| 2-4 (Inv.) | 69.8 | 0.8 | A |
| 2-5 (Inv.) | 68.7 | 0.7 | A |
| 2-6 (Inv.) | 68.4 | 0.9 | A |
| 2-7 (Inv.) | 69.3 | 0.4 | A |
| 2-8 (Inv.) | 69.9 | 0.4 | A |
| 2-9 (Inv.) | 70.4 | 0.3 | A |
| 2-10 (Inv.) | 70.7 | 0.2 | A |
| 2-11 (Inv.) | 70.6 | 0.2 | A |
| 2-12 (Inv.) | 70.5 | 0.2 | A |
| 2-13 (Comp.) | 53.2 | 0.2 | A |
| 2-14 (Comp.) | 52.6 | 0.3 | A |
| 2-15 (Comp.) | 51.9 | 0.3 | A |
| 2-16 (Comp.) | 72.3 | 3.9 | B |
| 2-17 (Comp.) | 69.7 | 2.6 | B |
| 2-18 (Comp.) | 68.6 | 3.7 | B |

As apparent from Table 2, OHP (overhead projection) quality exhibiting high transparency can be achieved by using color toners of the invention. There can also be provided images exhibiting superior storage stability as well as improved lightfastness over a long duration. Further, there has been achieved improvement in heat resistance (sublimation property) which has been a problem in toners using dyes.

What is claimed is:

1. An electrophotographic toner comprising at least a metal containing compound represented by the following formula (1): 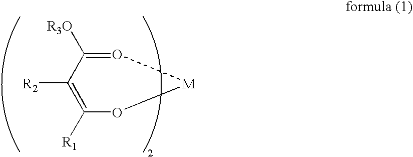
wherein M is a divalent metal ion; R₁ is a hydrogen atom or a substituent; R₂ is a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group; and R₃ is a hydrogen atom, an alkyl group, an alkenyl group, alkynyl group, an aryl group or a heterocyclic group.

2. The toner of claim 1, wherein M is a divalent metal ion selected from the group consisting of Ni²⁺, Cu²⁺ and Zn²⁺.

3. The toner of claim 1, wherein M is Cu²⁺.

4. The toner of claim 1, wherein R₁ is a hydrogen atom, an alkyl group, an alkenyl group, an aryl group, a heterocyclic group, an alkoxycarbonyl group, an acyl group, a carbamoyl group or cyano group.

5. The toner of claim 1, wherein R₁ or R₂ is an electron-withdrawing group.

6. The toner of claim 5, wherein a sum of Hammett σp values of R₁ and R₂ is 0.2 to 2.0.

7. The toner of claim 5, wherein the electron-withdrawing group is a cyano, trifluoromethyl, trichloromethyl, nitro, sulfinyl or sulfonyl group or an aryl or alkenyl group substituted by a cyano, trifluoromethyl, trichloromethyl, nitro, sulfinyl or sulfonyl group.

8. The toner of claim 1, wherein a ligand molecule forming the metal containing compound of formula (1) and represented by the following formula (2) exhibits a logP value of 3.00 to 8.00: 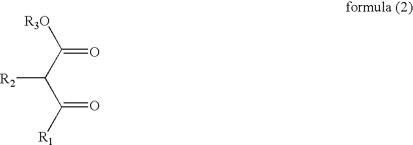
wherein R₁, R₂ and R₃ are each the same as defined in formula (1) .

9. The toner of claim 1, wherein the toner further comprises a dye and the dye is combined with the metal containing compound to form a metal chelate dye.

10. A method of preparing a toner comprising:
(a) dissolving a metal containing compound and a dye in a water-immiscible organic solvent to form a metal chelate dye,
(b) emulsifying the metal chelate dye in water to form an emulsion,
(c) removing the organic solvent to deposit colored particles, and
(d) allowing the colored particles to be coagulated and fused with a thermoplastic resin to form toner particles,
wherein the metal containing compound is represented by the following formula (1): 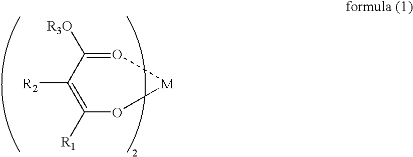
wherein M is a divalent metal ion; R₁ is a hydrogen atom or a substituent; R₂ is a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group; and R₃ is a hydrogen atom, an alkyl group, an alkenyl group, alkynyl group, an aryl group or a heterocyclic group.

11. The method of claim 10, wherein M is a divalent metal ion selected from the group consisting of Ni²⁺, Cu²⁺ and Zn²⁺.

12. The method of claim 10, wherein M is Cu²⁺.

13. The method of claim 10, wherein R₁ or R₂ is an electron-withdrawing group.

14. The method of claim 13, wherein a sum of σp values of R₁ and R₂ is 0.2 to 2.0.

15. The method of claim 13, wherein the electron-withdrawing group is a cyano, trifluoromethyl, trichloromethyl, nitro, sulfinyl or sulfonyl group or an aryl or alkenyl group substituted by a cyano, trifluoromethyl, trichloromethyl, nitro, sulfinyl or sulfonyl group.

16. The method of claim 10, wherein a ligand molecule forming the metal containing compound of formula (1) and represented by the following formula (2) exhibits a logP value of 3.00 to 8.00: 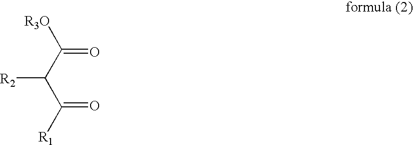
wherein R₁, R₂ and R₃ are each the same as defined in formula (1).

17. The method of claim 10, wherein in step (d), the thermoplastic resin is in the form of latex.
